(19) United States
(12) Patent Application Publication
(10) Pub. No.: US 2004/0046270 A1
(43) Pub. Date: Mar. 11, 2004

(54) Quenching of a hot gas mixture comprising (meth) acrylic acid

(76) Inventors: Volker Diehl, Ellerstadt (DE); Klaus Joachim Muller-Engel, Stutensee (DE); Gerhard Nestler, Stutensee (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,439

(22) PCT Filed: Dec. 13, 2001
(86) PCT No.: PCT/EP01/14634

(30) Foreign Application Priority Data
Dec. 18, 2000 (DE) 10063161.4

(51) Int. Cl. B01D 47/06

(52) U.S. Cl. 261/78.2

(57) ABSTRACT

In a process for quenching a hot gas mixture comprising (meth)acrylic acid by direct cooling by means of a cooling liquid in a spray cooler, the cooling liquid is atomized in the spray cooler by means of an impingement atomizer.

The present invention relates to a process for the rapid cooling (quenching) of a hot gas mixture comprising (meth)acrylic acid by direct cooling by means of a cooling liquid in a spray cooler (quench).

For the purposes of the present text, a spray cooler is an apparatus in which the cooling liquid is sprayed (broken up) into fine droplets by means of atomizers and the gas to be cooled is cooled by direct contact with the atomized cooling liquid. The sprayed cooling liquid and the gas to be cooled are generally conveyed in concurrent through the spray cooler. The cooling liquid is normally sprayed into the ascending or descending gas stream.

(Meth)acrylic acid is used here as an abbreviation for acrylic acid or methacrylic acid.

(Meth)acrylic acid, either itself or in the form of its esters, is of particular importance for the preparation of polymers for a wide variety of applications, e.g. use as adhesives.

(Meth)acrylic acid is obtainable by, inter alia, catalytic gas-phase oxidation of alkanes, alkanols, alkenes or alkenals containing 3 or 4 carbon atoms. (Meth)acrylic acid is particularly advantageously obtainable by, for example, catalytic gas-phase oxidation of propane, propene, tert-butanol, isobutene, isobutane, isobutyraldehyde or methacrolein. Further conceivable starting compounds are ones from which the actual C₃/C₄ starting compound is formed as an intermediate only during the gas-phase oxidation. An example which may be mentioned is the methyl ether of tert-butanol.

In such a process, the starting gases, generally diluted with inert gases such as nitrogen, CO, CO₂, saturated hydrocarbons and/or steam, are passed in admixture with oxygen at elevated temperatures (usually from about 200 to 400° C.) and at atmospheric or superatmospheric pressure over mixed oxide catalysts comprising transition metals (e.g. Mo, V, W and/or Fe) and oxidized to (meth)acrylic acid (cf., for example, DE-A 4 405 059, EP-A 253 409, EP-A 92 097, DE-A 4 431 957, DE-A 4 431 949, CN-A 1 105 352, WO 97/36849 and EP-A 608 838).

However, owing to numerous parallel and subsequent reactions occurring during the catalytic gas-phase oxidation and owing to the inert diluent gases which are concomitantly used, the catalytic gas-phase oxidation does not result in pure (meth)acrylic acid but instead produces a hot reaction gas mixture which consists essentially of (meth)acrylic acid, the inert diluent gases and by-products and from which the (meth)acrylic acid has to be separated off. Apart from by-products which are comparatively easy to remove from (meth)acrylic acid and interfere little in downstream uses of (meth)acrylic acid, e.g. acetic acid, the hot reaction gas mixture frequently further comprises lower aldehydes which are closely related to (meth)acrylic acid and are therefore difficult to separate from (meth)acrylic acid, for example formaldehyde, acetaldehyde, acrolein, methacrolein, propionaldehyde, n-butyraldehyde, propionic acid, bezaldehyde, furfural and crotonaldehyde, and possibly also maleic anhydride (the total amount of these secondary components, which frequently interfere considerably in downstream applications, is generally ≦2% by weight, usually >0.05% by weight, based on the amount of (meth)acrylic acid present in the reaction gas mixture).

It is known from DE-A 19 740 252, DE-A 19 740 253, DE-A 19 833 049, DE-A 19 814 375, DE-A 19 814 421, DE-A 19 814 449, DE-A 10 053 086, DE-A 10 039 025, DE-A 19 924 533 and DE-A 19 924 532 that a basic separation of the (meth)acrylic acid present in the hot product gas mixture from heterogeneously catalyzed gas-phase partial oxidations of C₃/C₄ precursors of (meth)acrylic acid can be carried out by subjecting the hot product gas mixture to direct precooling (quenching) by means of a cooling liquid and then partially or fully condensing it or absorbing it in a suitable absorption medium (e.g. water, (meth)acrylic acid, oligomeric (meth)acrylic acid (Michael adducts), high-boiling organic liquids and mixtures of the abovementioned liquids).

For example, removal of the absorption medium (and, if appropriate, prior desorption of impurities having a low solubility in the absorption medium by stripping, e.g. with air) by means of separation methods involving extraction, distillation and/or crystallization (e.g. removal of the absorption medium water by distillation, azeotropic distillation or extraction of the acid from the aqueous solution and subsequent removal of the extractant by distillation) and/or other separation steps frequently gives a (meth)acrylic acid which is referred to as crude (meth)acrylic acid (cf., for example, EP-A 297 445, DE-C 2 136 306).

To carry out the direct cooling of the hot product gas mixture from the heterogeneously catalyzed gas-phase partial oxidation of C₃/C₄ precursors of (meth)acrylic acid by means of a cooling liquid, DE-A 19 924 533 recommends the use of spray coolers which are free of internals.

To atomize the cooling liquid, DE-A 19 924 533 provides for the use of atomizer nozzles. The cooling liquid can, for example, be introduced under pressure into such nozzles. The cooling liquid is atomized by being pressurized in the orifice of the nozzle after reaching a certain minimum velocity. Furthermore, single-fluid nozzles such as swirl chamber nozzles (hollow cone or solid cone nozzles) are available for the above-mentioned purpose (e.g. from Dusen-Schlick GmbH, Germany, or from Spraying Systems Deutschland GmbH).

In the simplest case, the cooling liquid used can be chemically identical to the liquid used for the subsequent absorption.

However, a disadvantage of the atomizer nozzles used in the prior art for atomization is that they easily become blocked. This can be attributed, inter alia, to the fact that the reaction gas mixture to be cooled comprises in (meth)acrylic acid a constituent which has a high tendency to undergo free-radical polymerization. The resulting polymers are generally sticky and easily lead to blockage of the spray nozzles.

Subsequent cleaning of the blocked parts, e.g. by boiling with aqueous sodium hydroxide, is complicated and pollutes the environment.

It is an object of the present invention to provide an improved process for rapidly cooling a hot gas mixture comprising (meth)acrylic acid by direct cooling by means of a cooling liquid in a spray cooler.

We have found that this object is achieved by a process for cooling a hot gas mixture comprising (meth)acrylic acid by direct cooling by means of a cooling liquid in a spray cooler, in which at least one impingement atomizer is used for atomizing the cooling liquid in the spray cooler.

The impingement atomizer frequently produces, according to the present invention, a droplet size of from 0.1 mm to 5 mm.

In impingement atomizers, atomization is effected by at least one stream of the cooling liquid (quenching liquid) impinging either on at least a second stream of the cooling liquid and/or on an impingement plate.

According to the present invention, preference is given to impingement atomizers in which atomization is effected by at least one stream of the cooling liquid impinging on an impingement plate (e.g. of steel) (impingement plate atomizers).

According to the present invention, it is advantageous for the stream of cooling liquid directed onto the impingement plate to have a flow velocity of from 20 to 80 km/h.

The quenching liquid is advantageously conveyed through simple tubes (e.g. of steel) which are preferably tapered toward the end.

The distance between the outlet orifice of the tube and the impingement plate is, according to the present invention, frequently from 5 to 30 cm, advantageously from 10 to 20 cm. The size and shape of the impingement plate can be varied within a wide range. In general; the impingement plate is round and its diameter is frequently from 1 to 20 times, advantageously from 1 to 5 times, the diameter of the outlet orifice of the tube.

The impingement plate is normally flat. However, the impingement plate can also have a concave or convex shape.

According to the present invention, it is also advantageous for the surface of the impingement plate used to be provided with polymerization inhibitors (which are capable of inhibiting the free-radical polymerization of (meth)acrylic acid), as recommended by, for example, DE-A 19 915 116, DE-A 19 915 104 and DE-A 10 055 645 and also the references cited in these documents. The polymerization inhibition of the impingement plate is advantageously chosen so that it has a low solubility in the quenching liquid.

It is also useful, according to the present invention, for an added polymerization inhibitor to be present in the quenching liquid used. The polymerization inhibitor added is advantageously chosen so that it is soluble in the quenching liquid in the amount to be used.

Polymerization inhibitors suitable for the above purpose are, for example, phenolic compounds, amines, nitro compounds, phosphorusor sulfur-containing compounds, hydroxylamines, N-oxides and quinones. For example, all the polymerization inhibitors mentioned in DE-A 10 053 086 are possible.

The hot gas mixture comprising (meth)acrylic acid which is to be cooled according to the present invention is typically at from 200 to 400° C. and is usually cooled to from 100 to 180° C. by the direct cooling step. The temperature of the cooling liquid used according to the present invention is, for this purpose, normally from 70 to 170° C.

Quenching liquids which can be used according to the present invention are, for example, high-boiling inert hydrophobic organic liquids as are mentioned in DE-A 2 136 396 and DE-A 4 308 087. These are essentially liquids whose boiling point at atmospheric pressure is above 160° C. Examples which may be mentioned are middle oil fractions from paraffin distillation, diphenyl ether, biphenyl or mixtures of the liquids mentioned, e.g. a mixture of from 70 to 75% by weight of diphenyl ether and from 25 to 30% by weight of biphenyl. For example, the use of a mixture consisting of a mixture of from 70 to 75% by weight of diphenyl ether and from 25 to 30% by weight of biphenyl plus, based on this mixture, from 0.1 to 25% by weight of dimethyl o-phthalate is advantageous. Further liquids suitable as quenching liquids are alkyl carboxylates whose boiling point at atmospheric pressure (1 atm) is at least 160° C. and whose melting point is ≦30° C. (cf., for example DE-A 2 241 714).

Of course, it is also possible, according to the present invention, to use water, (meth)acrylic acid or a mixture of oligomeric (meth)acrylic acids (Michael adducts) as quenching liquid (cf., for example, DE-A 19 814 387).

The spray cooler to be used according to the present invention is advantageously a wide, upright tube or a preferably cylindrical shaft into which, for example, the hot reaction gas mixture comprising (meth)acrylic acid to be quenched is advantageously allowed to flow from above (preferably the middle).

In the upper part of the spray cooler there are from three to six feed tubes which are preferably arranged symmetrically and are distributed uniformly over the cross section (and are advantageously supplied with quenching liquid from a ring line), via which the quenching liquid is fed in. The feed tubes direct the quenching liquid onto likewise uniformly distributed and symmetrically arranged impingement plates. Apart from the feed tubes and the impingement plates, the spray cooler generally contains no further internals.

Relative to the inflow cross section of the hot reaction gas mixture., the impingement plates can be arranged either vertically (parallel to the direction of gas flow) or obliquely. This ensures spraying of the quenching head with quenching liquid. A horizontal arrangement is generally less advantageous.

The quenching liquid sprayed into the hot reaction gas mixture and the hot reaction gas mixture itself move in concurrent downward through the spray cooler. At the bottom end of the spray cooler, the quenching liquid is collected, discharged and, after cooling, reused for quenching. The cooled reaction gas mixture generally leaves the spray cooler via an outlet located on the opposite side and can, for example, be conveyed to an absorber for further work-up.

Such reaction gas mixtures can, for example, have the following composition:

from 1 to 30% by weight of acrylic acid,

from 0.01 to 3% by weight of acetic acid,

from 0.01 to 1% by weight of propionic acid,

from 0.01 to 0.5% by weight of maleic acid/maleic anhydride,

from 0.05 to 1% by weight of acrolein,

from 0.05 to 1% by weight of formaldehyde,

from 0.01 to 1% by weight of furfural,

from 0.01 to 0.5% by weight of benzaldehyde,

from 0.01 to 1% by weight of propene,

from 0.05 to 10% by weight of oxygen,

from 1 to 30% by weight of water and

as balance, inert gases such as nitrogen, carbon dioxide, methane and propane.

The gas-phase oxidation of propene itself can be carried out, for example, in two successive oxidation stages, as described in EP-A 700 714 and EP-A 700 893. Of course, the gas-phase oxidations cited in DE-A 19 740 253 and DE-A 19 740 252 can also be employed.

It is also possible for the impingement plates to be cooled indirectly in the process of the present invention.

### EXAMPLES

1. Comparative Example

150 000 standard m³/h of a reaction gas mixture comprising acrylic acid and obtained by catalytic gas-phase oxidation of acrolein as described in example B1 of DE-A 4 302 991 were fed at 270° C. centrally from above into a cylindrical (internal diameter=3 m) spray cooler.

As cooling liquid, use was made of a mixture of 57.4% by weight of diphenyl ether, 20.7% by weight of biphenyl and 21.9% by weight of dimethyl o-phthalate at 150° C. The cooling liquid contained 3000 ppm by weight of phenothiazine as polymerization inhibitor.

The cooling liquid was sprayed into the spray cooler via six downward-directed (i.e. directed in the flow direction of the reaction gas mixture) solid-cone spray nozzles uniformly distributed over the cross section of the spray cooler (and located 75 cm from the wall of the spray cooler).

After an operating time of seven days, malfunctions occurred. Detailed analyses indicated that the malfunctions were attributable to a reduced spraying capability of the spray nozzles. More precise investigations showed that the reduction was caused by deposits of polyacrylic acid in the nozzles.

2. Example according to the Present Invention

The procedure of the comparative example was repeated but the six spray nozzles were replaced by three impingement plate atomizers (which were likewise uniformly distributed over the cross section of the spray cooler). The impingement plates were circular, arranged vertically relative to the inflow cross section and had a diameter of 25 cm. The distance of the impingement plates from the wall of the spray cooler was 50 cm. The cooling liquid was directed onto the impingement plates at a velocity of 50 km/h by means of tubes. The distance from the outlet orifice of the tube to the impingement plate was 15 cm. The cooling action achieved corresponded to the cooling action achieved in the comparative example. Even after 30 days of uninterrupted operation, no malfunctions occurred.

We claim:

1. A process for cooling a hot gas mixture comprising (meth)acrylic acid by direct cooling by means of a cooling liquid in a spray cooler, wherein at least one impingement atomizer is used for atomizing the cooling liquid in the spray cooler.

2. A process as claimed in claim 1, wherein the impingement atomizer is an impingement plate atomizer.

3. A process as claimed in claim 2, wherein the impingement plate of the impingement plate atomizer is provided with polymerization inhibitors.

4. A process as claimed in any of claims 1 to 3, wherein the cooling liquid used is an organic liquid, water, (meth)acrylic acid, (meth)acrylic acid oligomers and/or a mixture of these liquids.

5. A process as claimed in any of claims 1 to 4, wherein the hot gas mixture is the product gas mixture from a heterogeneously catalyzed gas-phase oxidation of C₃/C₄ precursors of (meth)acrylic acid.
